(19) United States
(12) Patent Application Publication
(10) Pub. No.: US 2025/0234080 A1
(43) Pub. Date: Jul. 17, 2025

(54) LENS DEVICE

(71) Applicant: FUJIFILM Corporation, Tokyo (JP)

(72) Inventor: Nobuyuki KONDO, Saitama (JP)

(73) Assignee: FUJIFILM Corporation, Tokyo (JP)

(21) Appl. No.: 19/019,489

(22) Filed: Jan. 14, 2025

(30) Foreign Application Priority Data
Jan. 16, 2024 (JP) 2024-004536

(51) Int. Cl. H04N 23/55; G02B 7/02; G02B 7/09; G03B 17/12; H04N 23/667; H04N 23/67; H04N 23/69

(52) U.S. Cl. CPC H04N 23/55; G02B 7/021; G02B 7/023; G02B 7/09; G03B 17/12; H04N 23/667; H04N 23/67; H04N 23/69

(57) ABSTRACT

A lens device includes: a first lens; a first operation ring that is provided to be rotatable in a direction around an optical axis; a cam barrel that is connected to the first operation ring and that moves the first lens along the optical axis; and a first sensor that is provided at an end part of the cam barrel in an axial direction and that detects a rotation amount of the first operation ring.

### CROSS-REFERENCE TO RELATED APPLICATIONS

This application claims priority under 35 USC 119 from Japanese Patent Application No. 2024-004536 filed on Jan. 16, 2024, the disclosure of which is incorporated by reference herein.

### BACKGROUND OF THE INVENTION

### 1. Field of the Invention

The technology of the present disclosure relates to a lens device.

### 2. Description of the Related Art

JP2010-092030A discloses a lens barrel that is mountable on a camera body, the lens barrel comprising: a lens element; a lens support frame that supports the lens element; an actuator that is a unit fixed to the lens support frame and that includes a drive shaft and a detection unit for detecting rotation of the drive shaft; and an electrical contact portion that is disposed on a side opposite to the actuator with respect to the lens element in an optical axis direction in a case of being viewed in an optical axis direction parallel to an optical axis of the lens element and that is electrically connectable to the camera body.

JP2013-050510A discloses a sensor attachment structure of a lens barrel comprising: a lens barrel body that holds a lens; an operation ring that is disposed on an outer peripheral side of the lens barrel body and that is held to be rotatable in a circumferential direction with respect to the lens barrel body; a detection sensor that is provided on an outer peripheral surface of the lens barrel body and that detects an operation state of the operation ring; and a sensor support member that supports the detection sensor, in which the sensor support member is an arc-shaped member that is provided only in an arc region where the detection sensor is disposed in a circumferential direction of the outer peripheral surface of the lens barrel body, and the detection sensor is supported to face an inner peripheral surface of the operation ring.

JP2010-107740A discloses a lens position detection device that detects a position of a lens that is movable with respect to a fixed frame, the lens position detection device comprising: a first sheet coil that is provided in a lens frame that holds the lens or a movable unit that moves in conjunction with movement of the lens frame; a second sheet coil that is provided in a fixed unit facing the first sheet coil; an excitation circuit that uses any one of the first sheet coil or the second sheet coil as an excitation coil and the other as a detection coil and that provides an excitation signal to the excitation coil; and a signal processing circuit that, as the first sheet coil moves in a plane parallel to the second sheet coil while maintaining a facing distance to the second sheet coil in accordance with the movement of the lens frame, detects a position of the lens based on an electrical signal output from the detection coil in response to the movement position.

JP2014-232132A discloses a movement amount detection device comprising: a first member provided with a photoreflector including a light emitting section and a light receiving section; and a second member that is relatively moved with respect to the first member and in which a protrusion portion that is curved and protrudes and a recess portion that is curved and recessed are alternately provided at regular intervals on a facing surface with the photoreflector, in which a movement amount of the second member with respect to the first member is detected.

WO2016/039294A discloses a lens barrel that has a stop portion of which an opening diameter is changeable, a fixed cylinder portion that accommodates the stop portion, and a stop ring that is attached to the fixed cylinder portion so as to be rotationally movable and is configured to adjust the opening diameter of the stop portion, the lens barrel comprising: in a case in which a portion of the stop ring facing the fixed cylinder portion or a portion of the fixed cylinder portion facing the stop ring is a “first facing part” and a portion of the fixed cylinder portion facing the first facing part or a portion of the stop ring is a “second facing part”, first and second protrusions that are located at two positions along a circumferential direction of the stop portion so as to be biased from the stop portion toward the stop ring; a fitting portion that is formed on a side of the stop ring such that the first and second protrusions are alternatively fitted thereinto according to a rotational movement position of the stop ring, and the stop ring is integrally rotationally moved with the stop portion; a link releasing portion that is configured to release the first and second protrusions from the fitting portion so that the stop ring is rotationally moved in a state of being separated from the stop portion; and a click mechanism that is formed or disposed at the first facing part and the second facing part so as to give a click feeling to the rotational movement of the stop ring, in which the click mechanism has a click spring member attached to the first facing part, a locking member biased toward the second facing part by the click spring member, and a locked portion formed or disposed on a second facing part side so as to lock the locking member, the second facing part has a locked surface having a plurality of locked portions in the circumferential direction, and a substantially flat surface having no locked portion, and in a case in which the stop ring is rotationally moved with the first protrusion fitted into the fitting portion, the locking member slides on the locked surface, and in a case in which the stop ring is rotationally moved with the second protrusion fitted into the fitting portion, the locking member slides on the substantially flat surface.

### SUMMARY OF THE INVENTION

One embodiment according to the technology of the present disclosure provides a lens device that can be reduced in size in a radial direction as compared with the related art.

A first aspect according to the technology of the present disclosure provides a lens device comprising: a first lens; a first operation ring that is provided to be rotatable in a direction around an optical axis; a cam barrel that is connected to the first operation ring and that moves the first lens along the optical axis; and a first sensor that is provided at an end part of the cam barrel in an axial direction and that detects a rotation amount of the first operation ring.

A second aspect according to the technology of the present disclosure provides the lens device according to the first aspect, in which the cam barrel has a plurality of grooves, and the end part is located in a region closer to an image formation side than a groove located closest to the image formation side among the grooves.

A third aspect according to the technology of the present disclosure provides the lens device according to the first or second aspect, in which the first sensor includes a first substrate member that is provided in an arc shape along a circumferential direction of the cam barrel, and a first movable member that is connected to the cam barrel and that is movably attached to the first substrate member.

A fourth aspect according to the technology of the present disclosure provides the lens device according to the third aspect, in which the first movable member is provided on an outer peripheral side of the first substrate member.

A fifth aspect according to the technology of the present disclosure provides the lens device according to the fourth aspect, which further comprises: a first barrel member that is provided on a radially inner side of the cam barrel, in which the first substrate member is fixed to an outer peripheral surface of the first barrel member.

A sixth aspect according to the technology of the present disclosure provides the lens device according to the fifth aspect, in which the first substrate member is a member having a plate thickness in a radial direction of the first barrel member.

A seventh aspect according to the technology of the present disclosure provides the lens device according to the fifth or sixth aspect, which further comprises: a second barrel member that is provided on a radially outer side of the cam barrel, in which the second barrel member includes a facing wall that is located on an image formation side with respect to the cam barrel and that faces the cam barrel in a direction of the optical axis, a first region is provided between the cam barrel and the facing wall, and the first sensor is disposed in the first region.

An eighth aspect according to the technology of the present disclosure provides the lens device according to any one of the first to seventh aspects, in which the first sensor is a resistive linear position sensor.

A ninth aspect according to the technology of the present disclosure provides the lens device according to any one of the first to eighth aspects, in which the first lens is a zoom lens, and the first operation ring is a zoom ring.

A tenth aspect according to the technology of the present disclosure provides the lens device according to any one of the first to ninth aspects, which further comprises: a stop; a second operation ring that is provided to be rotatable around the optical axis and that is connected to the stop; and a second sensor that is provided on a radially outer side of the cam barrel and that detects a rotation amount of the second operation ring.

An eleventh aspect according to the technology of the present disclosure provides the lens device according to the tenth aspect, in which the second sensor includes a second substrate member that is provided in an arc shape along a circumferential direction of the cam barrel, and a second movable member that is connected to the second operation ring and that is movably attached to the second substrate member.

A twelfth aspect according to the technology of the present disclosure provides the lens device according to the eleventh aspect, in which the second movable member is provided on an inner peripheral side of the second substrate member.

A thirteenth aspect according to the technology of the present disclosure provides the lens device according to the twelfth aspect, which further comprises: a second barrel member that is provided on the radially outer side of the cam barrel, in which the second substrate member is fixed to an inner peripheral surface of the second barrel member.

A fourteenth aspect according to the technology of the present disclosure provides the lens device according to the thirteenth aspect, in which the second substrate member is a member having a plate thickness in a radial direction of the second barrel member.

A fifteenth aspect according to the technology of the present disclosure provides the lens device according to the thirteenth or fourteenth aspect, which further comprises: a second lens; and a movement member that moves the second lens along the optical axis, in which the second barrel member includes a first diameter portion having a first diameter and a second diameter portion having a second diameter, the movement member is provided inside the first diameter portion, the second diameter portion is located on an image formation side with respect to the movement member, a second region is provided between an end part of the movement member on the image formation side and the second diameter portion, and the second sensor is disposed in the second region.

A sixteenth aspect according to the technology of the present disclosure provides the lens device according to any one of the tenth to fifteenth aspects, in which the second sensor is disposed on an object side with respect to the second operation ring.

A seventeenth aspect according to the technology of the present disclosure provides the lens device according to any one of the tenth to sixteenth aspects, in which the second sensor is a resistive linear position sensor.

An eighteenth aspect according to the technology of the present disclosure provides the lens device according to any one of the tenth to seventeenth aspects, which further comprises: a click mechanism that imparts a click feeling to rotation of the second operation ring.

A nineteenth aspect according to the technology of the present disclosure provides the lens device according to the eighteenth aspect, in which the click mechanism includes a plurality of recess portions that are formed in the second operation ring and that are arranged in a rotation direction of the second operation ring, a protruding member that is selectively fitted into the plurality of recess portions in accordance with the rotation of the second operation ring, and a biasing member that biases the protruding member toward the plurality of recess portions.

### BRIEF DESCRIPTION OF THE DRAWINGS

FIG. 1 is a side view of a lens device according to an embodiment of the technology of the present disclosure.

FIG. 2 is a longitudinal cross-sectional view of the lens device.

FIG. 3 is a side view of a cam barrel assembly including a cam barrel, a first linear sensor, and a substrate.

FIG. 4 is a perspective view of the first linear sensor.

FIG. 5 is a transverse cross-sectional view of the lens device.

FIG. 6 is a perspective view of a second linear sensor.

FIG. 7 is a longitudinal cross-sectional view of an outer barrel assembly including an outer barrel, a stop ring, and the second linear sensor.

FIG. 8 is a perspective view of the stop ring and the second linear sensor.

FIG. 9 is a perspective view of the stop ring and the second linear sensor.

FIG. 10 is a perspective view of the stop ring.

FIG. 11 is an exploded perspective view of a rear cover assembly including a rotational movement member, a rear cover, a slide switch, a connecting member, and a first click mechanism.

FIG. 12 is a perspective view of the rotational movement member.

FIG. 13 is an enlarged perspective view of a peripheral portion of an opening in the rotational movement member.

FIG. 14 is a perspective view of the rear cover assembly and is a view showing a first state in which the slide switch is moved to a first movement position.

FIG. 15 is a longitudinal cross-sectional view of an outer barrel-rear cover assembly including the outer barrel, the stop ring, the rotational movement member, the rear cover, and the first click mechanism, and is a view showing the first state.

FIG. 16 is an enlarged longitudinal cross-sectional view of a peripheral portion (X portion) of the first click mechanism in the outer barrel-rear cover assembly and is a view showing the first state.

FIG. 17 is a perspective view of the rear cover assembly and is a view showing a second state in which the slide switch is moved to a second movement position.

FIG. 18 is a longitudinal cross-sectional view of the outer barrel-rear cover assembly and is a view showing the second state.

FIG. 19 is an enlarged longitudinal cross-sectional view of a peripheral portion (X portion) of the first click mechanism in the outer barrel-rear cover assembly and is a view showing the second state.

FIG. 20 is a front view of the rear cover.

FIG. 21 is an enlarged perspective view of a peripheral portion of a second click mechanism in the outer barrel-rear cover assembly.

FIG. 22 is an enlarged longitudinal cross-sectional view of the peripheral portion of the second click mechanism in the outer barrel-rear cover assembly.

FIG. 23 is an enlarged perspective view of an outer peripheral surface of the outer barrel-rear cover assembly.

### DESCRIPTION OF THE PREFERRED EMBODIMENTS

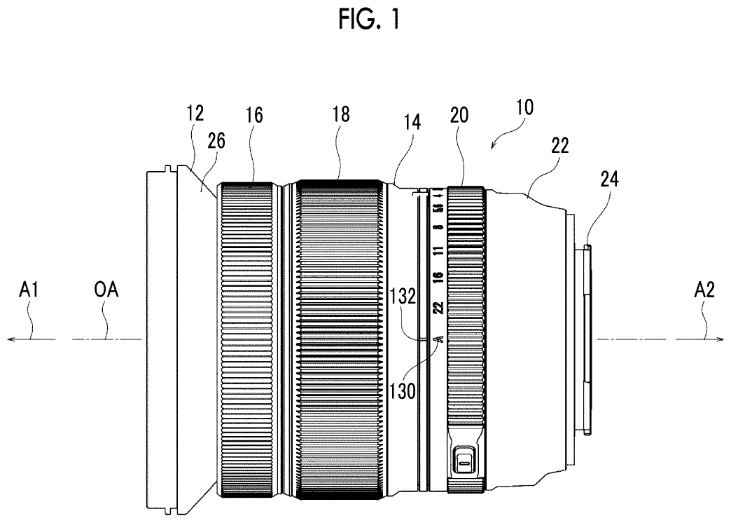

Hereinafter, an example of a lens device 10 according to one embodiment of the technology of the present disclosure will be described with reference to the accompanying drawings. In the following description, the description may be made over a plurality of drawings. As shown in FIG. 1, the lens device 10 according to the present embodiment is a lens device that can be applied to various cameras such as a digital still camera. An arrow A1 side indicates an object side, and an arrow A2 side indicates an image formation side. The lens device 10 has an optical axis OA. In the following description, a direction of the optical axis OA (hereinafter, referred to as an “optical axis direction”) refers to a direction parallel to the optical axis OA. In addition, a direction around the optical axis OA (hereinafter, referred to as a “direction around the optical axis”) refers to a circumferential direction centered on the optical axis OA.

The lens device 10 comprises a lens hood 12, an outer barrel 14, a focus ring 16, a zoom ring 18, a stop ring 20, a rear cover 22, and a mount 24. The lens hood 12 is disposed on the object side of the outer barrel 14, and the rear cover 22 is disposed on the image formation side of the outer barrel 14. The mount 24 is disposed at an end part of the rear cover 22 on the image formation side.

The lens hood 12 includes a hood portion 26. The focus ring 16, the zoom ring 18, and the stop ring 20 are disposed between the hood portion 26 and the rear cover 22. The focus ring 16, the zoom ring 18, and the stop ring 20 are disposed in the order of the focus ring 16, the zoom ring 18, and the stop ring 20 from the object side toward the image formation side.

The focus ring 16, the zoom ring 18, and the stop ring 20 are provided to be rotatable in the direction around the optical axis with respect to the outer barrel 14. Specifically, the focus ring 16, the zoom ring 18, and the stop ring 20 are formed in an annular shape along the direction around the optical axis. The focus ring 16, the zoom ring 18, and the stop ring 20 are disposed on a radially outer side of the outer barrel 14 and are supported to be rotatable in the direction around the optical axis with respect to the outer barrel 14.

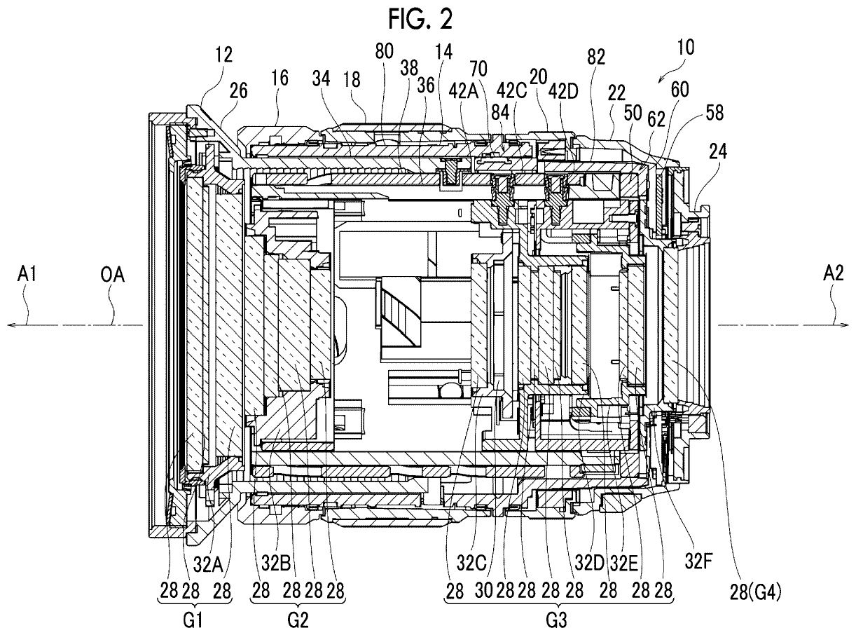

As shown in FIG. 2, the lens device 10 comprises a plurality of lenses 28 and a stop 30. The plurality of lenses 28 are classified into, for example, a first group G1, a second group G2, a third group G3, and a fourth group G4. The lenses 28 of the first group G1 are, for example, objective lenses, the lenses 28 of the second group G2 are, for example, focus lenses, the lenses 28 of the third group G3 are, for example, zoom lenses, and the lens 28 of the fourth group G4 is, for example, an image forming lens.

The lens device 10 comprises a first holding frame 32A, a second holding frame 32B, a third holding frame 32C, a fourth holding frame 32D, a fifth holding frame 32E, and a sixth holding frame 32F. The first holding frame 32A, the second holding frame 32B, the third holding frame 32C, the fourth holding frame 32D, the fifth holding frame 32E, and the sixth holding frame 32F are all formed in an annular shape along the direction around the optical axis.

The first holding frame 32A, the second holding frame 32B, the third holding frame 32C, the fourth holding frame 32D, the fifth holding frame 32E, and the sixth holding frame 32F are disposed in order of the first holding frame 32A, the second holding frame 32B, the third holding frame 32C, the fourth holding frame 32D, the fifth holding frame 32E, and the sixth holding frame 32F from the object side toward the image formation side.

The lens hood 12 has a cylindrical portion 34. The cylindrical portion 34 is disposed between a cam barrel 38, which will be described below, and the outer barrel 14 and is supported to be movable with respect to the outer barrel 14 along the optical axis. The first holding frame 32A is disposed on a radially inner side of the hood portion 26 and is held by the hood portion 26. The second holding frame 32B, the third holding frame 32C, the fourth holding frame 32D, and the fifth holding frame 32E are disposed on the radially inner side of an inner barrel 36, which will be described below, and are supported to be movable with respect to the inner barrel 36 along the optical axis. The sixth holding frame 32F is fixed to an end part of the outer barrel 14 on the image formation side.

The lenses 28 of the first group G1 are held by the first holding frame 32A, and the lenses 28 of the second group G2 are held by the second holding frame 32B. The lens 28 on the object side, among the lenses 28 of the third group G3, and the stop 30 are held by the third holding frame 32C, and the remaining lenses 28 among the lenses 28 of the third group G3 are held by the fourth holding frame 32D and the fifth holding frame 32E. The lens 28 of the fourth group G4 is held by the sixth holding frame 32F.

The lens device 10 comprises the outer barrel 14, the inner barrel 36, and the cam barrel 38. The outer barrel 14, the inner barrel 36, and the cam barrel 38 are all formed in a cylindrical shape. The outer barrel 14, the inner barrel 36, and the cam barrel 38 are disposed concentrically about the optical axis OA. The cam barrel 38 is disposed on the radially outer side of the inner barrel 36, and the outer barrel 14 is disposed on the radially outer side of the cam barrel 38. The outer barrel 14, the inner barrel 36, and the rear cover 22 are fixed to the mount 24, and the cam barrel 38 is supported to be rotatable in the direction around the optical axis with respect to the outer barrel 14 and the inner barrel 36.

The zoom ring 18 is connected to the cam barrel 38 via a first connection mechanism (not shown), and, in a case in which the zoom ring 18 rotates, the cam barrel 38 rotates. The stop 30 is a stop of which a size of an opening can be adjusted, and has a plurality of blades (not shown) capable of adjusting the size of the opening. The stop ring 20 is connected to the plurality of blades via a second connection mechanism (not shown), and, in a case in which the stop ring 20 rotates, the plurality of blades are operated to adjust the size of the opening of the stop 30.

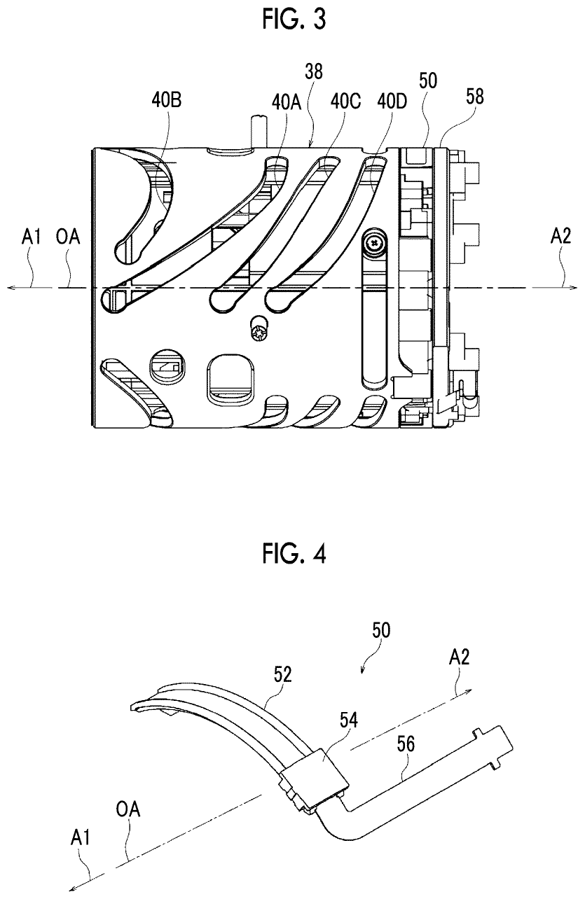

As shown in FIG. 3, the cam barrel 38 includes a first groove 40A, a second groove 40B, a third groove 40C, and a fourth groove 40D. The first groove 40A is a groove for moving the lenses 28 of the first group G1 along the optical axis. The second groove 40B is a groove for moving the lenses 28 of the second group G2 along the optical axis. The third groove 40C and the fourth groove 40D are grooves for moving the lenses 28 of the third group G3 along the optical axis.

A first roller 42A is provided in the cylindrical portion 34 of the lens hood 12, and the first roller 42A is movably inserted into the first groove 40A. A second roller (not shown) is provided in the second holding frame 32B, and the second roller is movably inserted into the second groove 40B. A third roller 42C is provided in the third holding frame 32C and the fourth holding frame 32D, and the third roller 42C is movably inserted into the third groove 40C. A fourth roller 42D is provided in the fifth holding frame 32E, and the fourth roller 42D is movably inserted into the fourth groove 40D.

In a case in which the cam barrel 38 rotates, the first roller 42A is moved with respect to the first groove 40A, so that a rotational force of the cam barrel 38 is converted into a linear force in the optical axis direction of the lens hood 12, and the lens hood 12 moves along the optical axis. In addition, in a case in which the cam barrel 38 rotates, the second roller moves with respect to the second groove 40B, so that the rotational force of the cam barrel 38 is converted into a linear force in the optical axis direction of the second holding frame 32B, and the second holding frame 32B moves along the optical axis.

Similarly, in a case in which the cam barrel 38 rotates, the third roller 42C moves with respect to the third groove 40C, so that the rotational force of the cam barrel 38 is converted into a linear force in the optical axis direction of the third holding frame 32C and the fourth holding frame 32D, and the third holding frame 32C and the fourth holding frame 32D move along the optical axis. In addition, in a case in which the cam barrel 38 rotates, the fourth roller 42D is moved with respect to the fourth groove 40D, so that a rotational force of the cam barrel 38 is converted into a linear force in the optical axis direction of the fifth holding frame 32E, and the fifth holding frame 32E moves along the optical axis.

As shown in FIG. 3, the lens device 10 comprises a first linear sensor 50. The first linear sensor 50 is a sensor that detects a rotation amount of the zoom ring 18 (specifically, a rotation amount of the cam barrel 38 in response to the rotation of the zoom ring 18). The zoom ring 18 is an example of a “first operation ring” in the technology of the present disclosure. The lens 28 of the third group G3, which moves in the optical axis direction with the rotation of the zoom ring 18, is an example of a “first lens” and a “zoom lens” in the technology of the present disclosure. The first linear sensor 50 is an example of a “first sensor” in the technology of the present disclosure.

The first linear sensor 50 is provided at an end part of the cam barrel 38 in an axial direction (for example, an end part of the cam barrel 38 on the image formation side). As described above, the cam barrel 38 has the first groove 40A, the second groove 40B, the third groove 40C, and the fourth groove 40D, and the first linear sensor 50 is disposed in a region closer to the image formation side than a groove (for example, the fourth groove 40D) located closest to the image formation side among the first groove 40A, the second groove 40B, the third groove 40C, and the fourth groove 40D as an example of the end part of the cam barrel 38 on the image formation side. The first groove 40A, the second groove 40B, the third groove 40C, and the fourth groove 40D are examples of a “plurality of grooves” in the technology of the present disclosure.

More specifically, the first linear sensor 50 is provided on an end surface of the cam barrel 38 in the axial direction (for example, an end surface of the cam barrel 38 on the image formation side). That is, the first linear sensor 50 is disposed on the image formation side of the cam barrel 38 in parallel with the cam barrel 38 in the optical axis direction.

As shown in FIG. 4, the first linear sensor 50 is, for example, an arc-shaped linear sensor, and is provided at the end part of the cam barrel 38 on the image formation side along a circumferential direction of the cam barrel 38. As an example, a resistive linear position sensor is used as the first linear sensor 50. In general, the resistive linear position sensor is a sensor having higher resolution than an absolute encoder.

The first linear sensor 50 includes a first substrate member 52 and a first movable member 54. The first substrate member 52 is provided in an arc shape along the circumferential direction of the cam barrel 38. The first substrate member 52 includes a conductor (not shown) that extends along the circumferential direction of the cam barrel 38. A first connecting member 56 is connected to the first substrate member 52. The first substrate member 52 and the first connecting member 56 are formed of, for example, flexible printed circuits (FPCs). The first connecting member 56 extends from one end of the first substrate member 52 in the axial direction of the cam barrel 38. A substrate 58 is disposed on the image formation side with respect to the cam barrel 38, and the first connecting member 56 is connected to the substrate 58.

The first substrate member 52 is fixed to the inner barrel 36 (see FIG. 2) provided on the radially inner side of the cam barrel 38. The first movable member 54 is movably attached to the first substrate member 52. The first movable member 54 is connected to the cam barrel 38. In a case in which the cam barrel 38 rotates with respect to the inner barrel 36, the first movable member 54 moves with respect to the first substrate member 52 with the rotation of the cam barrel 38. In a case in which the first movable member 54 moves with respect to the first substrate member 52, an electric resistance between the first movable member 54 and the first substrate member 52 changes. The first linear sensor 50 detects an electric resistance that changes in response to the rotation amount of the cam barrel 38 and outputs a signal corresponding to the detected electric resistance.

As an example, the first substrate member 52 is fixed to an outer peripheral surface of the inner barrel 36, and the first movable member 54 is provided on an outer peripheral side of the first substrate member 52. That is, the first linear sensor 50 is an outer sliding type sensor in which the first movable member 54 slides on the outer peripheral side of the first substrate member 52. The inner barrel 36 is an example of a “first barrel member” in the technology of the present disclosure. The first substrate member 52 is a member having a plate thickness in the radial direction of the inner barrel 36.

The outer barrel 14 provided on the radially outer side of the cam barrel 38 includes a bottom wall portion 60 (see FIG. 2). The bottom wall portion 60 is provided at the end part of the outer barrel 14 on the image formation side. The bottom wall portion 60 is located on the image formation side with respect to the cam barrel 38 and faces the cam barrel 38 in the optical axis direction. A first dead space 62 is provided between the cam barrel 38 and the bottom wall portion 60, and the first linear sensor 50 is disposed in the first dead space 62. The outer barrel 14 is an example of a “second barrel member” in the technology of the present disclosure. The bottom wall portion 60 is an example of a “facing wall” in the present disclosure. The first dead space 62 is an example of a “first region” in the present disclosure.

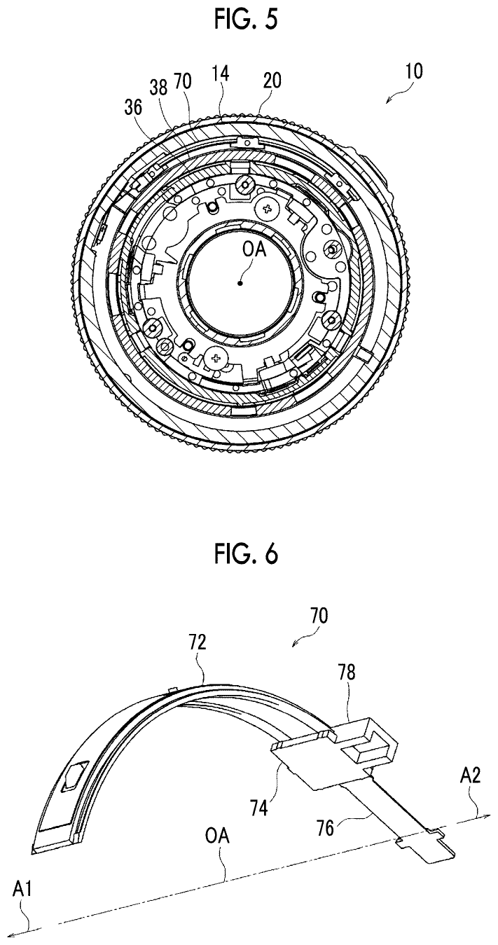

As shown in FIG. 5, the lens device 10 comprises a second linear sensor 70. The second linear sensor 70 is a sensor that detects a rotation amount of the stop ring 20. The second linear sensor 70 is provided on the radially outer side of the cam barrel 38. The stop ring 20 is an example of a “second operation ring” in the technology of the present disclosure. The second linear sensor 70 is an example of a “second sensor” in the technology of the present disclosure. As shown in FIG. 6, the second linear sensor 70 is, for example, an arc-shaped linear sensor, and is provided on the radially outer side of the cam barrel 38 along the circumferential direction of the cam barrel 38. As an example, a resistive linear position sensor is used as the second linear sensor 70.

The second linear sensor 70 includes a second substrate member 72 and a second movable member 74. The second substrate member 72 is provided in an arc shape along the circumferential direction of the cam barrel 38. The second substrate member 72 includes a conductor (not shown) that extends along the circumferential direction of the cam barrel 38. A second connecting member 76 is connected to the second substrate member 72. The second substrate member 72 and the second connecting member 76 are formed of, for example, flexible printed circuits. The second connecting member 76 extends from one end of the second substrate member 72 in the circumferential direction of the cam barrel 38. The second connecting member 76 is connected to the substrate 58 (see FIG. 3).

The second substrate member 72 is fixed to the outer barrel 14 (see FIG. 2) provided on the radially outer side of the cam barrel 38. The second movable member 74 is movably attached to the second substrate member 72. The second movable member 74 is connected to the stop ring 20 via the connecting portion 78. In a case in which the stop ring 20 rotates with respect to the outer barrel 14, the second movable member 74 moves with respect to the second substrate member 72 with the rotation of the stop ring 20. In a case in which the second movable member 74 moves with respect to the second substrate member 72, an electric resistance between the second movable member 74 and the second substrate member 72 changes. The second linear sensor 70 detects an electric resistance that changes in response to the rotation amount of the stop ring 20 and outputs a signal corresponding to the detected electric resistance.

As an example, the second substrate member 72 is fixed to an inner peripheral surface of the outer barrel 14, and the second movable member 74 is provided on an inner peripheral side of the second substrate member 72. That is, the second linear sensor 70 is an inner sliding type sensor in which the second movable member 74 slides on the inner peripheral side of the second substrate member 72. The second substrate member 72 is a member having a plate thickness in the radial direction of the outer barrel 14.

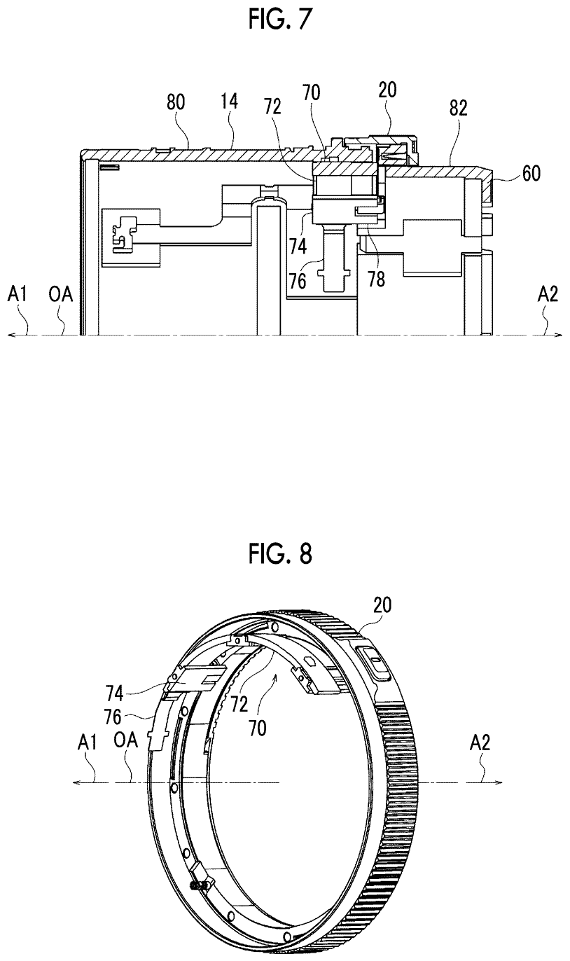

The outer barrel 14 (see FIG. 2) has a portion having an outer diameter of a first diameter (hereinafter, referred to as a “first diameter portion 80”) and a portion having an outer diameter of a second diameter (hereinafter, referred to as a “second diameter portion 82”). The first diameter is larger than the second diameter. The hood portion 26 of the lens hood 12 is provided inside the first diameter portion 80, and the second diameter portion 82 of the outer barrel 14 is located on the image formation side with respect to the hood portion 26. A second dead space 84 is provided between an end part of the hood portion 26 on the image formation side and the second diameter portion 82, and the second linear sensor 70 is disposed in the second dead space 84. The lens 28 provided in the lens hood 12 is an example of a “second lens” according to the technology of the present disclosure. The hood portion 26 of the lens hood 12 is an example of a “movement member” according to the technology of the present disclosure. The second dead space 84 is an example of a “second region” in the present disclosure. As shown in FIG. 7, the second linear sensor 70 is disposed on the object side with respect to the stop ring 20.

The second linear sensor 70 may be an outer sliding type sensor in which the second movable member 74 slides on the outer peripheral side of the second substrate member 72. Then, the second substrate member 72 may be fixed to, for example, the outer peripheral surface of the inner barrel 36, and the second movable member 74 may be provided on the outer peripheral side of the second substrate member 72.

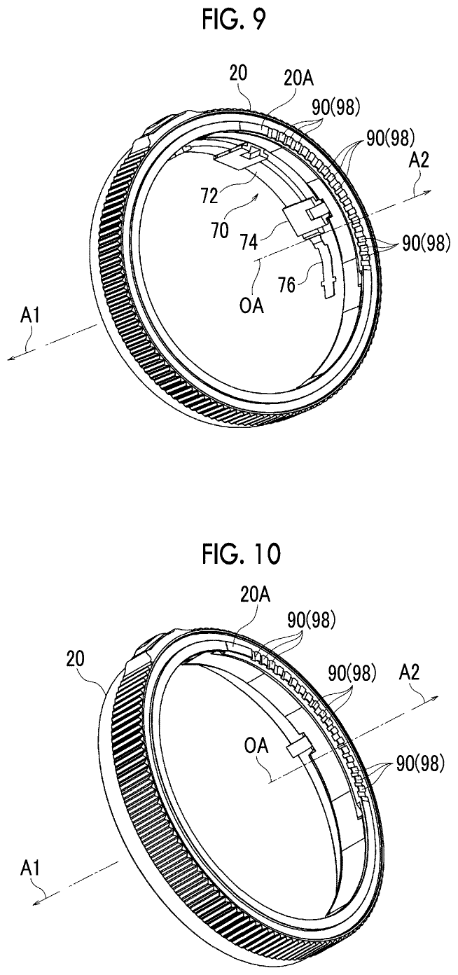

As shown in FIGS. 9 and 10, a plurality of recess portions 90 arranged in a rotation direction of the stop ring 20 are formed on an image formation side surface 20A of the stop ring 20. The plurality of recess portions 90 are all open to the image formation side. The image formation side surface 20A of the stop ring 20 is an example of a “first surface” according to the technology of the present disclosure.

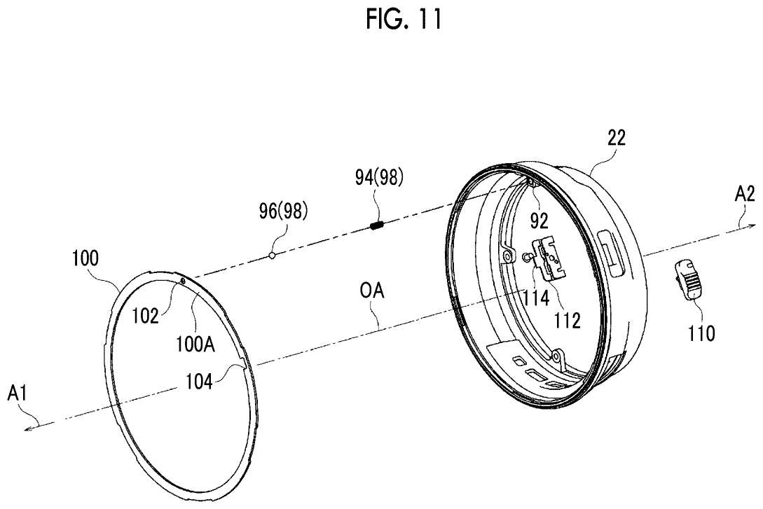

As shown in FIG. 11, a first holding portion 92 is formed in the rear cover 22. The first holding portion 92 is formed in a cylindrical shape having a direction parallel to the optical axis direction as an axis. A first spring 94 is accommodated inside the first holding portion 92, and a first ball member 96, which is a ball-shaped member, is provided on the object side of the first spring 94. The first spring 94 is, for example, a coil spring. The first ball member 96 is biased to a side of the plurality of recess portions 90 (that is, the object side) by the first spring 94 and is selectively fitted into the plurality of recess portions 90 in accordance with the rotation of the stop ring 20.

The first ball member 96 is selectively fitted into the plurality of recess portions 90 in accordance with the rotation of the stop ring 20, so that a click feeling is obtained with respect to the rotation of the stop ring 20. That is, the plurality of recess portions 90, the first ball member 96, and the first spring 94 constitute a first click mechanism 98 that imparts a click feeling to the rotation of the stop ring 20. In a state in which the first ball member 96 is fitted into any of the plurality of recess portions 90, the stop ring 20 is locked to the rear cover 22, so that the first click mechanism 98 constitutes a locking mechanism that locks the operation ring to the rear cover 22. The stop ring 20 is an example of an “operation ring” according to the technology of the present disclosure. The first ball member 96 is an example of a “protruding member” according to the technology of the present disclosure. The first spring 94 is an example of a “biasing member” according to the technology of the present disclosure. The first click mechanism 98 is an example of a “click mechanism” and a “locking mechanism” according to the technology of the present disclosure.

The first spring 94 may be various springs other than the coil spring. In addition, a biasing member such as a rubber material may be used instead of the first spring 94. In addition, instead of the first ball member 96, for example, a protruding member having a shape other than a ball shape may be used.

A rotational movement member 100 is provided on the object side of the rear cover 22. The rotational movement member 100 is formed in an annular shape (for example, a circular ring shape) along the direction around the optical axis. The rotational movement member 100 is supported to be rotatable in the direction around the optical axis with respect to the rear cover 22. The rotational movement member 100 is disposed to face the image formation side surface 20A of the stop ring 20. The rotational movement member 100 is an example of a “first member” according to the technology of the present disclosure. The rotational movement member 100 may be formed in an arc shape along the direction around the optical axis.

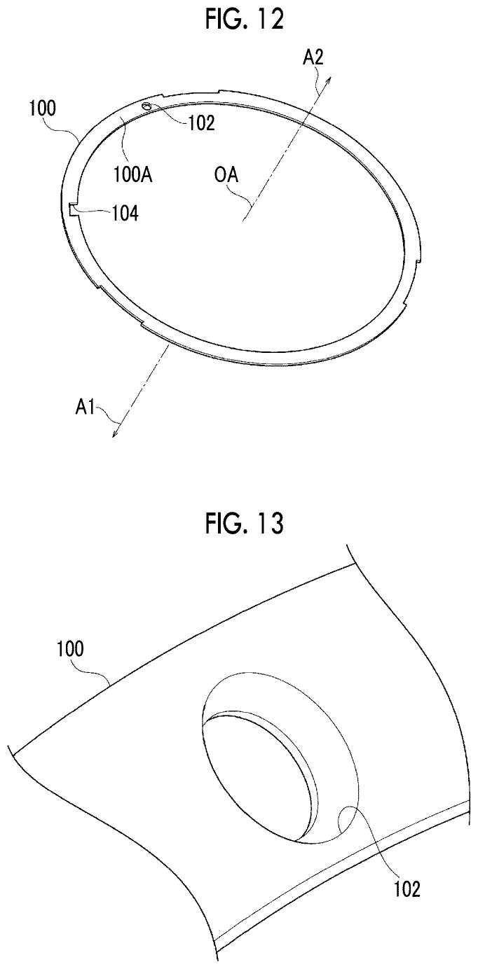

As shown in FIGS. 12 and 13, the rotational movement member 100 has an opening 102 that penetrates along the optical axis direction. The opening 102 is, for example, a through hole. The opening 102 may be a notch. The opening 102 has a size such that the first ball member 96 can be inserted into the opening 102. The opening 102 has a gradient such that a diameter increases toward a side opposite to the image formation side surface 20A of the stop ring 20 (that is, the image formation side). In addition, the rotational movement member 100 includes a locked portion 104. The locked portion 104 is formed in a recessed shape.

The rear cover 22 is provided with a slide switch 110. The slide switch 110 is supported to be movable in the direction around the optical axis (that is, the circumferential direction of the rear cover 22) with respect to the rear cover 22. The slide switch 110 is connected to the rotational movement member 100 via a connecting member 112. Specifically, the connecting member 112 is fixed to the slide switch 110, and a locking portion 114 that is locked to the locked portion 104 is formed in the connecting member 112. The locking portion 114 is formed in a protruding shape.

The slide switch 110 is a member for switching a rotational position of the rotational movement member 100 between a first position and a second position. The slide switch 110 is an example of a “switching member” according to the technology of the present disclosure. The rotational position of the rotational movement member 100 is an example of a “movement position” according to the technology of the present disclosure. The rear cover 22 is an example of a “second member” according to the technology of the present disclosure.

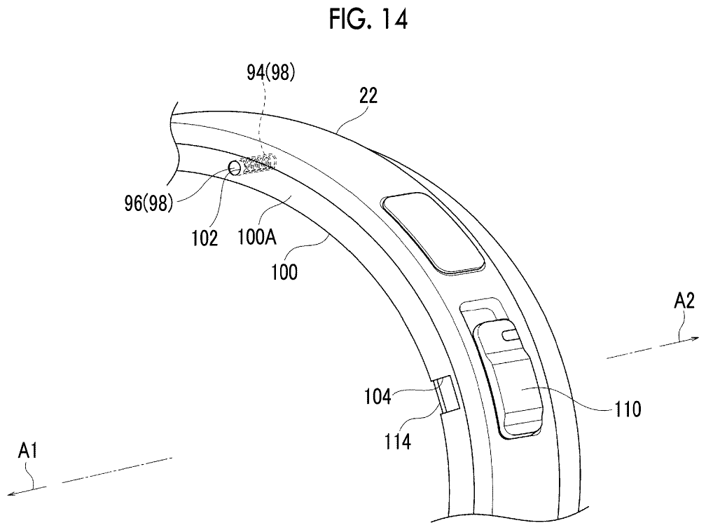

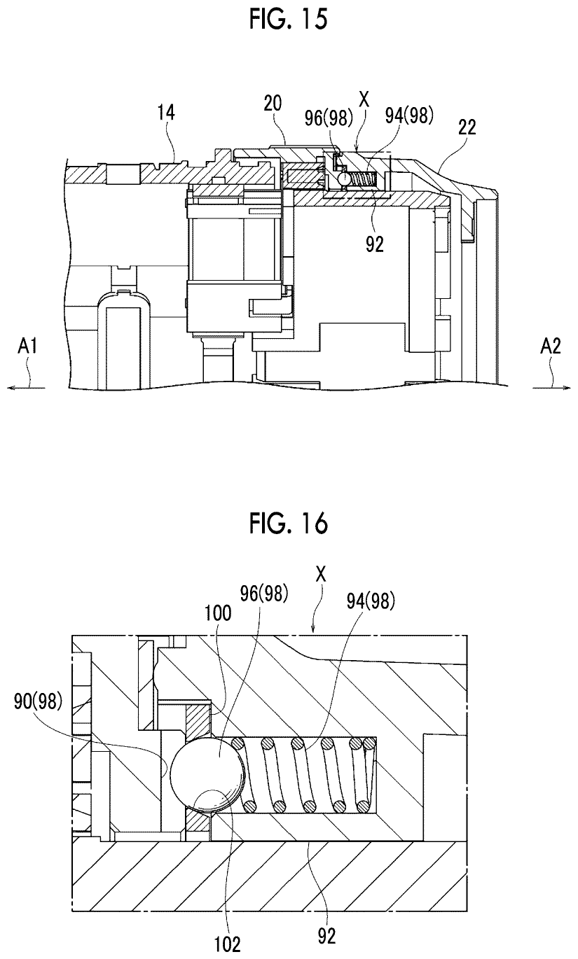

As shown in FIGS. 14 to 16, in a case in which the slide switch 110 is moved to a first movement position, the rotational position of the rotational movement member 100 becomes the first position, and the opening 102 is moved to a position corresponding to the first ball member 96. In a state in which the opening 102 is moved to the position corresponding to the first ball member 96, the first ball member 96 is inserted into the opening 102, and a portion of the first ball member 96 on the object side protrudes from the opening 102 (hereinafter, referred to as a “first state”). In the first state, the first ball member 96 is selectively fitted into the plurality of recess portions 90 via the opening 102 in accordance with the rotation of the stop ring 20, so that a click feeling is imparted to the rotation of the stop ring 20.

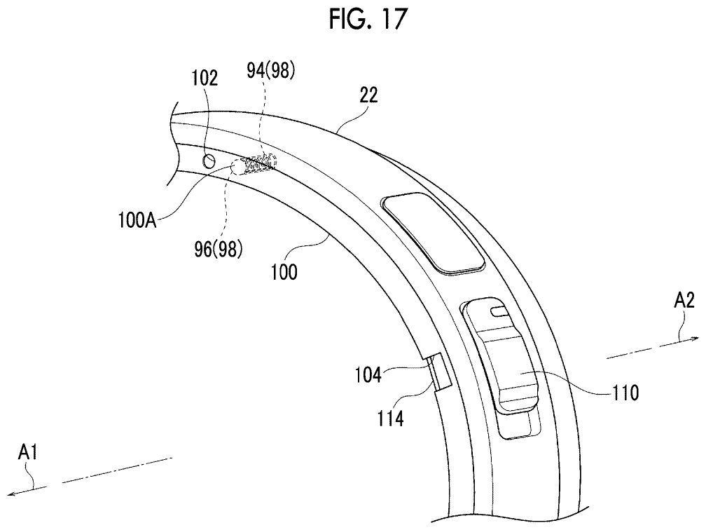

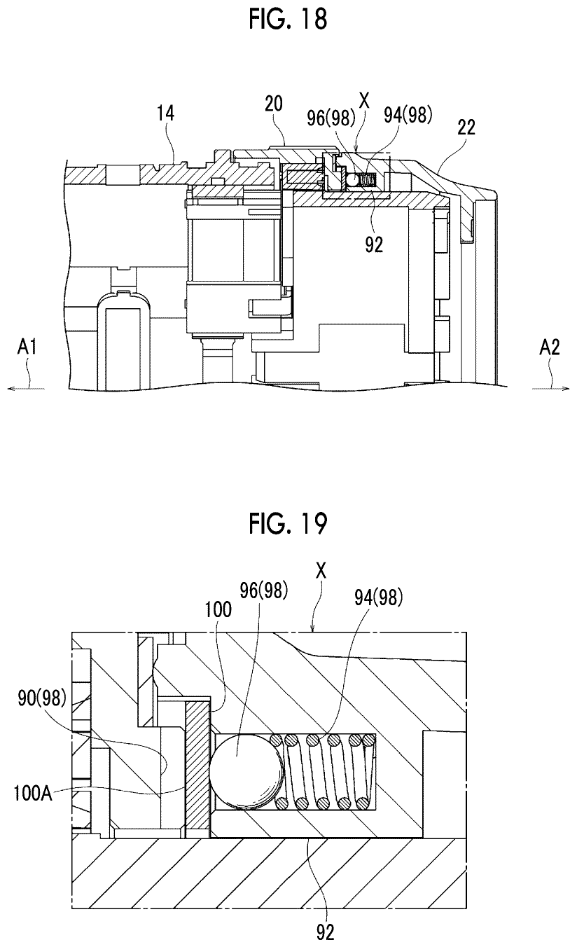

As shown in FIGS. 17 to 19, in a case in which the slide switch 110 is moved to a second movement position on a side opposite to the first movement position, the rotational position of the rotational movement member 100 becomes the second position different from the first position, and a region other than the opening 102 (hereinafter, referred to as a “closed region 100A”) in the rotational movement member 100 is moved to the position corresponding to the first ball member 96. In a state in which the closed region 100A is moved to the position corresponding to the first ball member 96, the first ball member 96 comes into contact with the closed region 100A from the side opposite to the image formation side surface 20A of the stop ring 20 (that is, the image formation side) (hereinafter, referred to as a “second state”). In the second state, even in a case in which the stop ring 20 rotates, the first ball member 96 is not fitted into the recess portion 90 because the first ball member 96 is maintained in a state of being in contact with the closed region 100A, so that a click feeling is not imparted to the rotation of the stop ring 20.

For example, in a case in which a video is captured by an imaging apparatus on which the lens device 10 is mounted, it is desirable that a click sound accompanied by the click feeling is not generated. Therefore, in a case in which a video is captured, the slide switch 110 need only be moved to the second movement position.

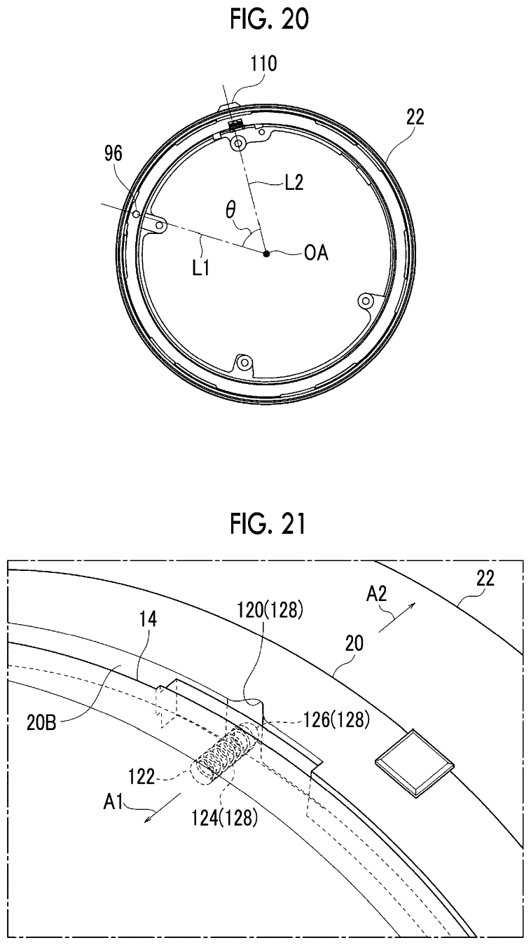

As shown in FIG. 20, an inner angle θ formed by a first line segment L1 connecting the first ball member 96 and the optical axis OA and a second line segment L2 connecting the slide switch 110 and the optical axis OA is set to an acute angle as viewed in the optical axis direction. More specifically, the first line segment L1 is a line segment connecting the center of the first ball member 96 and the optical axis OA. More specifically, the second line segment L2 is a line segment connecting the optical axis and the center of the slide switch 110 in the first state (for example, the center of the slide switch 110 in the entire length direction along the direction around the optical axis). The angle θ is set to, for example, 30° or more and less than 90°.

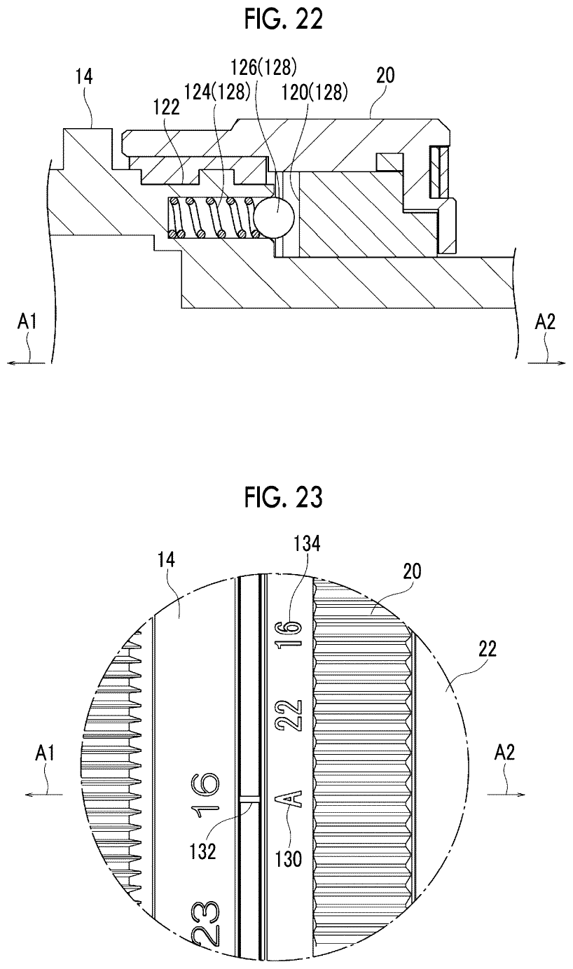

As shown in FIGS. 21 and 22, a groove 120 is formed on an object side surface 20B of the stop ring 20. The object side surface 20B of the stop ring 20 is an example of a “second surface” according to the technology of the present disclosure. The groove 120 is open to the object side and is formed in a V-shape as viewed in a direction orthogonal to the optical axis OA.

A second holding portion 122 is formed in the outer barrel 14. The second holding portion 122 is formed in a cylindrical shape having a direction parallel to the optical axis direction as an axis. A second spring 124 is accommodated inside the second holding portion 122, and a second ball member 126, which is a ball-shaped member, is provided on the image formation side of the second spring 124. The second spring 124 is, for example, a coil spring. The second ball member 126 is biased to a side of the groove 120 (that is, the image formation side) by the second spring 124. In a case in which a rotational position of the stop ring 20 is a specific rotational position (hereinafter, referred to as a “first rotational position”), the groove 120 is moved to a position corresponding to the second ball member 126, so that the second ball member 126 is fitted into the groove 120.

The second ball member 126 is fitted into the groove 120, thereby obtaining a click feeling with respect to the rotation of the stop ring 20. That is, the groove 120, the second ball member 126, and the second spring 124 constitute a second click mechanism 128 that imparts a click feeling to the rotation of the stop ring 20. In a state in which the second ball member 126 is fitted into any of the groove 120, the stop ring 20 is locked to the outer barrel 14, so that the second click mechanism 128 constitutes a locking mechanism that locks the operation ring to the outer barrel 14. The second ball member 126 is an example of a “fitting member” according to the technology of the present disclosure.

The second spring 124 may be various springs other than the coil spring. In addition, a biasing member such as a rubber material may be used instead of the second spring 124. In addition, instead of the second ball member 126, for example, a protruding member having a shape other than a ball shape may be used.

The imaging apparatus on which the lens device 10 is mounted has a first mode and a second mode associated with the stop 30. For example, the first mode is a mode in which an F number is automatically set (that is, an auto mode), and the second mode is a mode in which the F number is manually set (that is, a manual mode).

As shown in FIG. 23, a character “A” representing the auto mode is marked on an outer peripheral surface of the stop ring 20 as an example of an indicator 130 representing the first mode. A bar is marked on an outer peripheral surface of the outer barrel 14 as an example of an indicator 132 representing the rotational position of the stop ring 20. The first rotational position of the stop ring 20 is set to a position corresponding to the indicator 130. That is, in a case in which the rotational position of the stop ring 20 is the first rotational position, the indicator 130 is moved to a position corresponding to the indicator 132. In a case in which the rotational position of the stop ring 20 is the first rotational position, the imaging apparatus on which the lens device 10 is mounted enters the first mode (that is, the auto mode). On the other hand, in a case in which the rotational position of the stop ring 20 is a rotational position other than the first rotational position, the imaging apparatus on which the lens device 10 is mounted enters the second mode (that is, the manual mode), and the F number is set according to the rotational position of the stop ring 20. A numerical value 134 indicating the F number is indicated on the outer peripheral surface of the stop ring 20.

In a case in which the slide switch 110 is moved to the second movement position (see FIGS. 17 to 19), no click feeling is generated by the first click mechanism 98 even in a case in which the stop ring 20 is rotated. However, in a case in which the rotational position of the stop ring 20 is the first rotational position (see FIGS. 21 to 23), a click feeling is generated by the second click mechanism 128, so that a user can be informed by the click feeling generated by the second click mechanism 128 that the rotational position of the stop ring 20 is the first rotational position and that the imaging apparatus to which the lens device 10 is attached has entered the auto mode in which the F number is automatically set.

Next, the effects of the present embodiment will be described.

As described above, in the lens device 10 according to the present embodiment, the first linear sensor 50 that detects the rotation amount of the zoom ring 18 is an arc-shaped linear sensor that extends along the circumferential direction of the cam barrel 38 and is provided at the end part of the cam barrel 38 in the axial direction. Therefore, for example, the lens device 10 can be reduced in size in the radial direction as compared with a case in which the first linear sensor 50 is a direct-acting linear sensor that extends in the axial direction of the cam barrel 38 and is provided on the radially outer side of the cam barrel 38.

That is, in a case in which the first linear sensor 50 is a direct-acting linear sensor and is provided on the radially outer side of the cam barrel 38, the outer barrel 14 disposed on the radially outer side of the cam barrel 38 needs to have a deformed configuration (for example, a shape obtained by adding a rectangle to a circle) to avoid the direct-acting linear sensor or to be expanded in the radial direction to avoid interference with the direct-acting linear sensor. On the other hand, in the lens device 10 according to the present embodiment, since the first linear sensor 50 is an arc-shaped linear sensor that extends along the circumferential direction of the cam barrel 38 and is provided at the end part of the cam barrel 38 in the axial direction, the outer barrel 14 disposed on the radially outer side of the cam barrel 38 can be prevented from having a deformed configuration having a shape to avoid the first linear sensor 50 or from being expanded in the radial direction to avoid interference with the first linear sensor 50.

In addition, the first linear sensor 50 is disposed in a region closer to the image formation side than a groove (for example, the fourth groove 40D) located closest to the image formation side among the first groove 40A, the second groove 40B, the third groove 40C, and the fourth groove 40D formed in the cam barrel 38. Therefore, it is possible to avoid the interference between the first linear sensor 50 and the first roller 42A, the second roller (not shown), the third roller 42C, and the fourth roller 42D inserted into the first groove 40A, the second groove 40B, the third groove 40C, and the fourth groove 40D, respectively.

In addition, the first linear sensor 50 includes the first substrate member 52 that is provided in an arc shape along the circumferential direction of the cam barrel 38, and the first movable member 54 that is connected to the cam barrel 38 and that is movably attached to the first substrate member 52. The first substrate member 52 is fixed to the outer peripheral surface of the inner barrel 36 provided on the radially inner side of the cam barrel 38, and the first movable member 54 is provided on the outer peripheral side of the first substrate member 52. Therefore, for example, it is possible to prevent the first movable member 54 from protruding toward the lens 28 provided on the radially inner side of the inner barrel 36 as compared with a case in which the first substrate member 52 is fixed to an inner peripheral surface of the cam barrel 38 and the first movable member 54 is provided on the inner peripheral side of the first substrate member 52. Therefore, it is possible to reduce the size of the lens device 10 in the radial direction.

In addition, the first substrate member 52 is a member having a plate thickness in the radial direction of the inner barrel 36. Therefore, for example, the lens device 10 can be reduced in size in the radial direction as compared with a case in which the first substrate member 52 is a member having a plate thickness in the axial direction of the inner barrel 36.

In addition, the first linear sensor 50 is disposed in the first dead space 62 provided between the cam barrel 38 and the bottom wall portion 60 of the outer barrel 14 provided on the radially outer side of the cam barrel 38. Therefore, for example, the lens device 10 can be reduced in size in the axial direction as compared with a case in which a dedicated space for disposing the first linear sensor 50 is provided.

In addition, a resistive linear position sensor is used as the first linear sensor 50. Therefore, for example, the resolution in a case of detecting the rotation amount of the zoom ring 18 can be increased as compared with a case in which an absolute encoder is used.

In addition, the second linear sensor 70 that detects the rotation amount of the stop ring 20 is provided on the radially outer side of the cam barrel 38. The second linear sensor 70 includes the second substrate member 72 that is provided in an arc shape along the circumferential direction of the cam barrel 38, and the second movable member 74 that is connected to the stop ring 20 and that is movably attached to the second substrate member 72. The second substrate member 72 is fixed to the inner peripheral surface of the outer barrel 14 provided on the radially outer side of the cam barrel 38, and the second movable member 74 is provided on the inner peripheral side of the second substrate member 72. Therefore, for example, the rotation amount of the stop ring 20 can be detected with a simple structure as compared with a case in which the second linear sensor 70 is provided on the radially inner side of the cam barrel 38.

In addition, the second substrate member 72 is a member having a plate thickness in the radial direction of the outer barrel 14. Therefore, for example, the lens device 10 can be reduced in size in the radial direction as compared with a case in which the second substrate member 72 is a member having a plate thickness in the axial direction of the outer barrel 14.

In addition, the second linear sensor 70 is disposed in the second dead space 84 provided between the end part of the hood portion 26 on the image formation side and the second diameter portion 82 of the outer barrel 14. Therefore, for example, the lens device 10 can be reduced in size in the axial direction as compared with a case in which a dedicated space for disposing the second linear sensor 70 is provided.

In addition, the second linear sensor 70 is disposed on the object side with respect to the stop ring 20. Here, the object side with respect to the stop ring 20 has a more structural space than the image formation side with respect to the stop ring 20. Therefore, for example, a degree of freedom in the disposition of the second linear sensor 70 can be increased as compared with a case in which the second linear sensor 70 is disposed on the image formation side with respect to the stop ring 20.

In addition, a resistive linear position sensor is used as the second linear sensor 70. Therefore, for example, the resolution in a case of detecting the rotation amount of the stop ring 20 can be increased as compared with a case in which an absolute encoder is used.

In addition, the rotational movement member 100 is provided on the rear cover 22 so as to be rotatable in the direction around the optical axis, and, in a case in which the rotational position of the rotational movement member 100 is the first position, the first ball member 96 is selectively fitted into the plurality of recess portions 90 in accordance with the rotation of the stop ring 20. Accordingly, it is possible to impart a click feeling to the rotation of the stop ring 20. In addition, in a state in which the first ball member 96 is fitted into any of the plurality of recess portions 90, the stop ring 20 can be locked to the rear cover 22.

In addition, in a case in which the rotational position of the rotational movement member 100 is the second position, the first ball member 96 comes into contact with the closed region 100A, which is a region other than the opening 102 in the rotational movement member 100, from the image formation side. Accordingly, it is possible to prevent a click feeling from being applied to the rotation of the stop ring 20.

In addition, the rotational movement member 100 faces the image formation side surface 20A of the stop ring 20 and is provided on the rear cover 22 so as to be rotatable in the direction around the optical axis. Therefore, for example, the lens device 10 can be reduced in size in the radial direction as compared with a case in which a movement member that moves in the axial direction of the rear cover 22 is provided on the radially inner side of the rear cover 22 instead of the rotational movement member 100.

That is, in a case in which a movement member that moves in the axial direction of the rear cover 22 is provided on the radially inner side of the rear cover 22 instead of the rotational movement member 100, it is necessary to expand the rear cover 22 in the radial direction to avoid interference with the movement member. On the other hand, in the lens device 10 according to the present embodiment, since the rotational movement member 100 faces the image formation side surface 20A of the stop ring 20 and is provided on the rear cover 22 so as to be rotatable in the direction around the optical axis, it is possible to prevent the rear cover 22 from expanding in the radial direction to avoid interference with the rotational movement member 100.

In addition, the rear cover 22 is provided with the slide switch 110 that is connected to the rotational movement member 100. Therefore, the rotational position of the rotational movement member 100 can be switched between the first position and the second position by moving the slide switch 110.

In addition, the slide switch 110 is supported to be movable in the direction around the optical axis with respect to the rear cover 22. Therefore, since the movement direction of the slide switch 110 and the rotation direction of the stop ring 20 are the same direction, the operability of the slide switch 110 can be improved as compared with, for example, a case in which the slide switch 110 is supported to be movable in the optical axis direction with respect to the rear cover 22. In addition, since the connection structure between the slide switch 110 and the rear cover 22 can be simplified as compared with a case in which the slide switch 110 is supported to be movable in the optical axis direction with respect to the rear cover 22, the lens device 10 can be reduced in size in the radial direction.

In addition, the rotational movement member 100 is formed in an annular shape along the direction around the optical axis. Therefore, for example, the rigidity of the rotational movement member 100 can be increased as compared with a case in which the rotational movement member 100 is formed in an arc shape along the direction around the optical axis.

In addition, the inner angle θ formed by the first line segment L1 connecting the first ball member 96 and the optical axis OA and the second line segment L2 connecting the slide switch 110 and the optical axis OA is set to an acute angle as viewed in the optical axis direction. Therefore, for example, the first ball member 96 and the slide switch 110 can be brought closer to each other than in a case in which the first line segment L1 and the second line segment L2 are set at an obtuse angle. Accordingly, in a case in which the rotational movement member 100 is rotated by hooking a finger on the slide switch 110, the first ball member 96 comes into contact with a peripheral edge portion of the opening 102, thereby reducing the moment acting on the first ball member 96.

In addition, the opening 102 has a gradient such that a diameter increases toward the image formation side. Therefore, since the first ball member 96 can be guided to the inside of the opening 102 as the slide switch 110 is moved to the first movement position, the first ball member 96 can be smoothly inserted into the opening 102 as compared with, for example, a case in which the diameter of the opening 102 is constant.

In addition, the groove 120 is formed in the stop ring 20, and the second ball member 126 is fitted into the groove 120 in a case in which the rotational position of the stop ring 20 is the first rotational position. Accordingly, the user can be informed by the click feeling generated by the second click mechanism 128 that the rotational position of the stop ring 20 is the first rotational position.

In addition, the first rotational position of the stop ring 20 is a position corresponding to the indicator 130 (for example, a character “A” representing the auto mode) representing the first mode associated with the stop 30. Accordingly, the user can be informed by the click feeling generated by the second click mechanism 128 that the imaging apparatus on which the lens device 10 is mounted has entered the auto mode in which the F number is automatically set.

The above contents and illustrations are detailed descriptions of the parts according to the technology of the present disclosure, and are merely examples of the technology of the present disclosure. For example, description related to the above configurations, functions, actions, and effects is description related to an example of configurations, functions, actions, and effects of the parts according to the embodiments of the technology of the present disclosure. Thus, it is needless to say that unnecessary portions may be deleted, new elements may be added, or replacement may be made to the content of the above description and the content of the drawings without departing from the gist of the technology of the present disclosure. In order to avoid complication and easily understand the parts relating to the technology of the present disclosure, in the content of the above description and the content of the drawings, the description regarding common general technical knowledge which is not necessarily particularly described in terms of embodying the technology of the present disclosure is omitted.

What is claimed is:

1. A lens device comprising:
a first lens;
a first operation ring that is provided to be rotatable in a direction around an optical axis;
a cam barrel that is connected to the first operation ring and that moves the first lens along the optical axis; and
a first sensor that is provided at an end part of the cam barrel in an axial direction and that detects a rotation amount of the first operation ring.

2. The lens device according to claim 1,
wherein the cam barrel has a plurality of grooves, and
the end part is located in a region closer to an image formation side than a groove located closest to the image formation side among the grooves.

3. The lens device according to claim 1,
wherein the first sensor includes
a first substrate member that is provided in an arc shape along a circumferential direction of the cam barrel, and
a first movable member that is connected to the cam barrel and that is movably attached to the first substrate member.

4. The lens device according to claim 3,
wherein the first movable member is provided on an outer peripheral side of the first substrate member.

5. The lens device according to claim 4, further comprising:
a first barrel member that is provided on a radially inner side of the cam barrel,
wherein the first substrate member is fixed to an outer peripheral surface of the first barrel member.

6. The lens device according to claim 5,
wherein the first substrate member is a member having a plate thickness in a radial direction of the first barrel member.

7. The lens device according to claim 5, further comprising:
a second barrel member that is provided on a radially outer side of the cam barrel,
wherein the second barrel member includes a facing wall that is located on an image formation side with respect to the cam barrel and that faces the cam barrel in a direction of the optical axis,
a first region is provided between the cam barrel and the facing wall, and
the first sensor is disposed in the first region.

8. The lens device according to claim 1,
wherein the first sensor is a resistive linear position sensor.

9. The lens device according to claim 1,
wherein the first lens is a zoom lens, and
the first operation ring is a zoom ring.

10. The lens device according to claim 1, further comprising:
a stop;
a second operation ring that is provided to be rotatable around the optical axis and that is connected to the stop; and
a second sensor that is provided on a radially outer side of the cam barrel and that detects a rotation amount of the second operation ring.

11. The lens device according to claim 10,
wherein the second sensor includes
a second substrate member that is provided in an arc shape along a circumferential direction of the cam barrel, and
a second movable member that is connected to the second operation ring and that is movably attached to the second substrate member.

12. The lens device according to claim 11,
wherein the second movable member is provided on an inner peripheral side of the second substrate member.

13. The lens device according to claim 12, further comprising:
a second barrel member that is provided on the radially outer side of the cam barrel,
wherein the second substrate member is fixed to an inner peripheral surface of the second barrel member.

14. The lens device according to claim 13,
wherein the second substrate member is a member having a plate thickness in a radial direction of the second barrel member.

15. The lens device according to claim 13, further comprising:
a second lens; and
a movement member that moves the second lens along the optical axis,
wherein the second barrel member includes a first diameter portion having a first diameter and a second diameter portion having a second diameter,
the movement member is provided inside the first diameter portion,
the second diameter portion is located on an image formation side with respect to the movement member,
a second region is provided between an end part of the movement member on the image formation side and the second diameter portion, and
the second sensor is disposed in the second region.

16. The lens device according to claim 10,
wherein the second sensor is disposed on an object side with respect to the second operation ring.

17. The lens device according to claim 10,
wherein the second sensor is a resistive linear position sensor.

18. The lens device according to claim 10, further comprising:
a click mechanism that imparts a click feeling to rotation of the second operation ring.

19. The lens device according to claim 18,
wherein the click mechanism includes
a plurality of recess portions that are formed in the second operation ring and that are arranged in a rotation direction of the second operation ring,
a protruding member that is selectively fitted into the plurality of recess portions in accordance with the rotation of the second operation ring, and
a biasing member that biases the protruding member toward the plurality of recess portions.
